(19) United States
(12) Patent Application Publication
(10) Pub. No.: US 2015/0038276 A1
(43) Pub. Date: Feb. 5, 2015

(54) TRANSMISSION SYSTEM FOR TRANFER CASE

(71) Applicant: HYUNDAI WIA CORPORATION, Gyeongsangnam-do (KR)

(72) Inventor: Kyu Won Lee, Gyeonggi-do (KR)

(21) Appl. No.: 14/447,148

(22) Filed: Jul. 30, 2014

(30) Foreign Application Priority Data
Jul. 31, 2013 (KR) 10-2013-0091229

(51) Int. Cl. B60K 23/08; B60W 10/119; B60W 10/02

(52) U.S. Cl. CPC B60K 23/08; B60W 10/02; B60W 10/119
USPC 475/127

(57) ABSTRACT

A transmission system for a transfer case can change a high range mode to a low range mode without a shifting shock even while a vehicle is traveling at a constant speed. The transmission system includes a hydraulic system including a hydraulic circuit and a hydraulic cylinder connected to the hydraulic circuit and receiving a hydraulic pressure from a hydraulic pressure source. The transmission system further includes a clutch piston apparatus mounted on a housing of the transfer case and including a clutch piston receiving a hydraulic pressure from the hydraulic pressure source. An operating rod of the hydraulic cylinder is connected to a shift sleeve, and the clutch piston of the clutch piston apparatus is connected to the ring gear of the planetary gear assembly to make the ring gear not rotate according to the operation of the clutch piston supplied with the hydraulic pressure.

### CROSS-REFERENCE TO RELATED APPLICATION

This application claims priority to and the benefit of Korean Patent Application No. 10-2013-0091229 filed on Jul. 31, 2013, which is herein incorporated by reference in its entirety.

### BACKGROUND OF THE INVENTION

1. Field of the Invention

Aspects of the present invention relate to a transfer case, and more particularly, to a transmission system for a transfer case, which can change a high range mode to a low range mode without a shifting shock even while a vehicle is traveling at a constant speed.

2. Description of the Related Art

In general, an automotive vehicle includes a power transmission apparatus for transmitting power from an engine to driving wheels. Specifically, in a four (4)-wheel drive (4WD) vehicle, a power is transmitted to both of front wheels and rear wheels to drive all of the driving wheels.

The 4WD vehicle exhibits vehicle stability while it travels along a wet rainy road or snowy or icy road, and enhanced traveling performance on an off road, like a gravel road or a bumpy road.

A transfer case, which is a kind of auxiliary transmission devices mounded on a 4WD vehicle, is mounted at a rear side of a transmission system to distribute power to front and rear wheels.

An electronically controlled transfer case mounted on a 4WD vehicle is equipped with drive modes of an auto mode and a low mode, and changes speeds to provide an appropriate driving force by reducing the power transmitted from the transmission system according to road conditions. That is to say, when the 4WD vehicle travels along an ordinary road, since a large diving force is not required, the vehicle travels in the auto mode. Also, when the 4WD vehicle travels along a rough road or a road with a gradient, since a large diving force is required, the vehicle travels in the low mode.

FIG. 1 is a schematic diagram illustrating a general power transmission system of a 4 WD vehicle a transfer case.

In a rear-wheel driving mode, a driving force of an engine 1 is transmitted to rear wheels R through a transmission 2, a rear-wheel driving shaft 3 and a rear axle assembly 5. In order to set a four-wheel driving system, a transfer case 100 is installed between the transmission 2 and the rear-wheel driving shaft 3. In addition, the transfer case 100 distributes a driving force to front wheels F through a front axle assembly 4.

The transfer case 100 includes a mode switching system 110 and a transmission system 120. The mode switching system 110 of the transfer case 100 provides shifting between a two wheel drive (2WD) mode and a four wheel drive (4WD) mode, and the transmission system 120 provides shifting between a high range mode and a low range mode.

The high range mode is a driving mode selected for achieving a stable traveling of a vehicle by increasing a grounding force through uniform power distribution by each 25% to front and rear wheels in order to avoid a slip or tire damages due to each 50% of excessive power transmitted to rear wheels on a non-paved road or a bad-condition road. In a normal traveling state, even when the road condition is bad due to snow or rain, the vehicle traveling in the high range mode exhibits highly efficient driving performance (with an average gear ratio of 1:1).

The low range mode is a driving mode selected when a maximum pulling capacity and highly efficient driving performance are required. When a vehicle rises along a road with a steep slope or a vehicle is pulled, the vehicle traveling in the low range mode exhibits highly efficient driving performance. In particular, the vehicle traveling in the low range mode exhibits superior performance in escaping from a severely conditioned, rough, non-paved road (e.g., a muddy road, a road with crevices, a side slant surface road, a sharply sloping road, and so on).

FIGS. 2A and 3A are cross-sectional views of the general transmission system of the transfer case shown in FIG. 1. Here, FIG. 2A illustrates the transmission system in the high range mode and FIG. 3A illustrates the transmission system in the low range mode.

The transmission system 120 includes a planetary gear assembly mounted on an input shaft 10 (connected to an output shaft of the transmission), and the planetary gear assembly includes a sun gear 30, a pinion gear 40, a ring gear 50 and a carrier 41.

In the general transmission system 120, the ring gear 50 is fixed to a housing (not shown) and the sun gear 30 and the pinion gear 40 are rotated within the ring gear 50. The transmission system 120 further includes a shift sleeve 60 connected to a hydraulic system (not shown in FIGS. 2A and 3A), and the shift sleeve 60 is disposed around the input shaft 10.

A transmission process of the general transmission system having the aforementioned configuration will be briefly described with reference to the drawings.

FIGS. 2B and 3B illustrate power transmission routes in the high and low range modes shown in FIGS. 2A and 3A. In FIGS. 2B and 3B, in particular, a hydraulic system for moving the shift sleeve 60 which is not shown in FIGS. 2A and 3A is illustrated.

In FIGS. 2B and 3B, arrows indicate power transmission routes, components marked by dotted lines are in a stopped state and components marked by solid lines are in a rotating state.

The hydraulic system includes a hydraulic circuit (not shown) and a hydraulic cylinder 90 connected to the hydraulic circuit and receiving a hydraulic pressure from a hydraulic pressure source. An operating rod 91 of the hydraulic cylinder 90 is connected to the shift sleeve 60, so that the shift sleeve 60 may be moved along the input shaft 10 by the hydraulic cylinder 90.

In the high range mode, the shift sleeve 60 disposed around the input shaft 10 is connected to the sun gear 30 and the carrier 41 of the planetary gear assembly and the ring gear 50 is capable of freely rotating. Therefore, a rotation speed of the input shaft 10 (that is, a rotation speed of the sun gear 30), an output speed of the sun gear (that is, a rotation speed of the carrier 41) and a rotation speed of the output shaft 20 become equal to each other (the state as shown in FIGS. 2A and 2B).

When a driver changes the vehicle speed from the high range mode to the low range mode, the hydraulic system is operated and the shift sleeve 60 is moved to the left side in the drawing (opposite to the output shaft 20) by the hydraulic cylinder 90.

Therefore, a reaction ring 70 which is being in a fixed state all the time is connected to the ring gear 50 through the shift sleeve 60, so that the ring gear 50 does not rotate. As the result, the output speed (the rotation speed of the carrier 41) is reduced, and a transmission torque is increased by a speed reduction ratio and is simultaneously transmitted to the output shaft 20 (the state as shown in FIGS. 3A and 3B).

As shown in the above drawings and described, the general transmission system of the transfer case has not a gear synchronizer and the transmission is achieved only by gear engagement using the shift sleeve 60. Therefore, a change of speed from the high range mode to the low range mode can be achieved only when a vehicle is in a stopped state or travels in the low range mode.

FIG. 6A is a graph illustrating a change in the number of revolutions during a transmission stage of the transmission system of the transfer case shown in FIGS. 2A and 3A. Referring to FIG. 6A, when a speed of the vehicle traveling at a constant speed is changed from the high range mode to the low range mode, a shifting shock is generated, this shifting shock causes a damage to various gears constituting the planetary gear assembly.

### SUMMARY OF THE INVENTION

Aspects of the present invention provide a transmission system for a transfer case, which can change a high range mode to a low range mode without a shifting shock even while a vehicle is traveling at a constant speed.

In accordance with one aspect of the present invention, there is provided a transmission system for a transfer case, including a planetary gear assembly having a sun gear, a pinion gear, a ring gear and a carrier, and a shift sleeve, the transmission system including a hydraulic system including a hydraulic circuit and a hydraulic cylinder connected to the hydraulic circuit and receiving a hydraulic pressure from a hydraulic pressure source, and a clutch piston apparatus mounted on a housing of the transfer case and including a clutch piston receiving a hydraulic pressure from the hydraulic pressure source, wherein an operating rod of the hydraulic cylinder is connected to the shift sleeve to shift the shift sleeve, and the clutch piston of the clutch piston apparatus is connected to the ring gear of the planetary gear assembly to make the ring gear not rotate according to the operation of the clutch piston supplied with the hydraulic pressure.

The hydraulic pressure source and the hydraulic cylinder may be connected to each other through a first hydraulic pressure supply pipe, and the clutch piston may be connected to the hydraulic pressure source through a second hydraulic pressure supply pipe branched from the first hydraulic pressure supply pipe.

In the aforementioned transmission system for a transfer case according to the present invention, a high range mode can be changed to a low range mode without a shifting shock even while a vehicle is traveling at a constant speed.

Additional aspects and/or advantages of the invention will be set forth in part in the description which follows and, in part, will be obvious from the description, or may be learned by practice of the invention.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a schematic diagram illustrating a general transmission system of a 4-wheel drive vehicle having a transfer case;

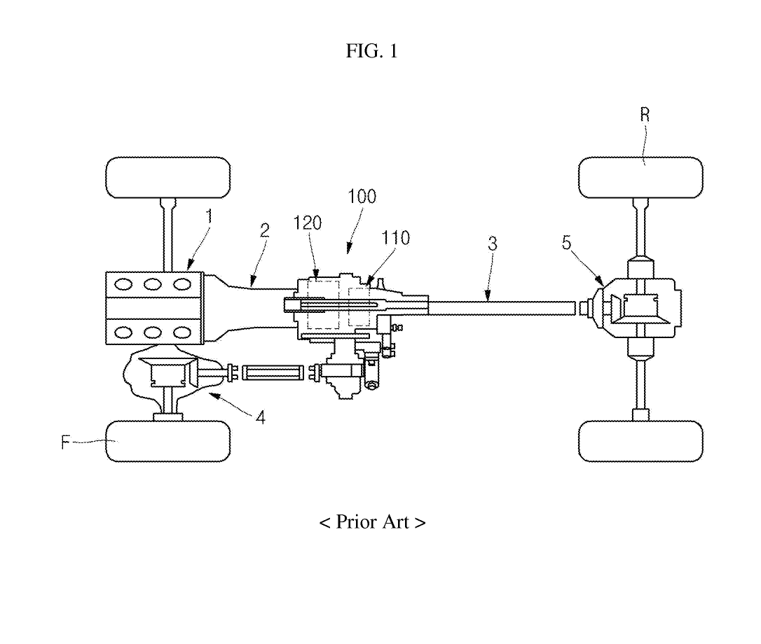

FIG. 2A is a cross-sectional view of the general transmission system of a transfer case shown in FIG. 1 in a high range mode;

FIG. 2B illustrates a power transmission route as shown in FIG. 2A;

FIG. 3A is a cross-sectional view of the general transmission system of a transfer case shown in FIG. 1 in a low range mode;

FIG. 3B illustrates a power transmission route as shown in FIG. 3A;

FIG. 4 corresponds to FIG. 2B and illustrates transmission route of the transmission system of the transfer case according to the preferred embodiment of the present invention in a high range mode;

FIG. 5 corresponds to FIG. 3B and illustrates transmission route of the transmission system of the transfer case according to the preferred embodiment of the present invention in a low range mode;

FIG. 6A is a graph illustrating a change in the number of revolutions during a transmission stage of the general transmission system shown in FIGS. 2A and 3A; and

FIG. 6B is a graph illustrating a change in the number of revolutions during a transmission stage of the transmission system of the transfer case according to the present invention shown in FIGS. 4 and 5.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present disclosure will be described in detail with reference to the accompanying drawings in such a manner that the technical idea of the present disclosure may easily be carried out by a person with ordinary skill in the art to which the invention pertains. Objects, operations, effects, other objects, characteristics and advantages of the present disclosure will be easily understood from an explanation of a preferred embodiment that will be described in detail below by reference to the attached drawings.

Although embodiments have been described with reference to illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims.

Hereinafter, a configuration and functions of a transmission system for a transfer case according to an exemplary embodiment of the present invention will be described with reference to the accompanying drawings.

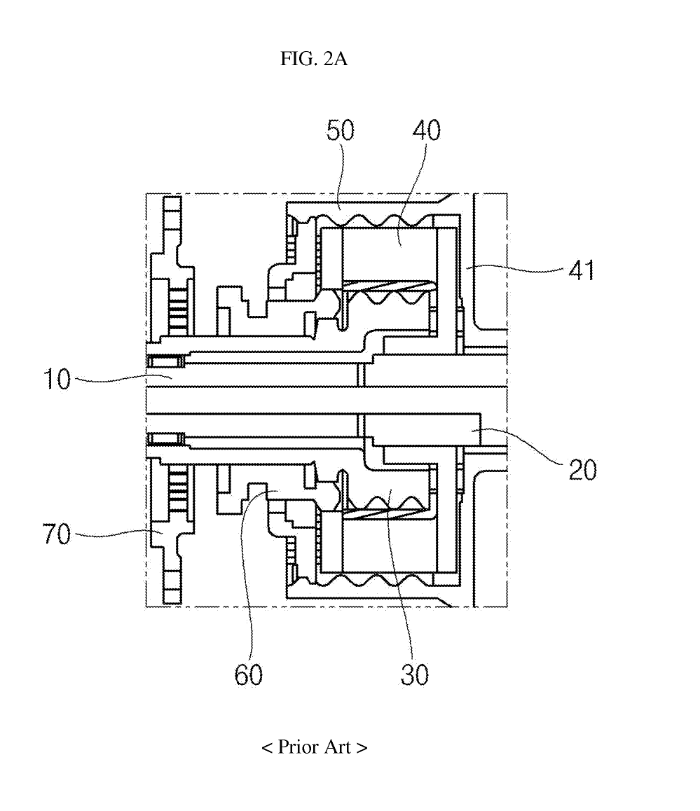

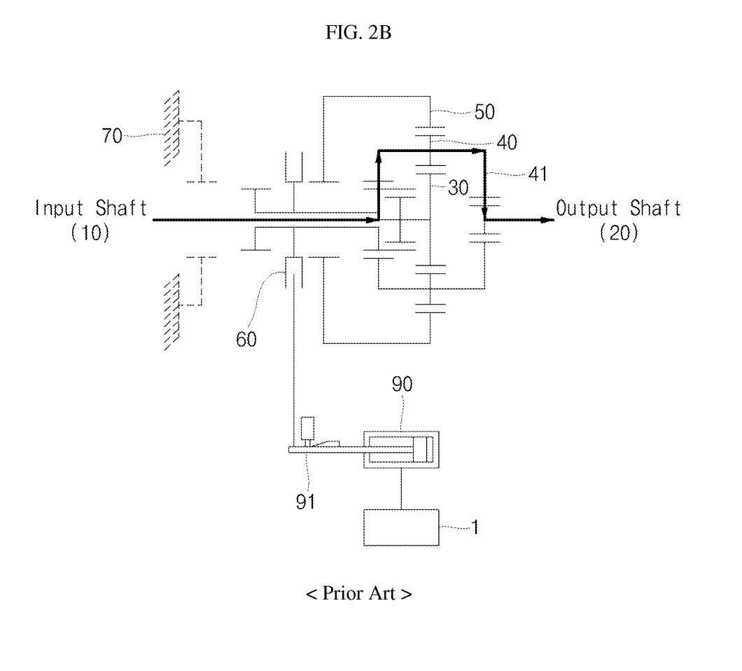

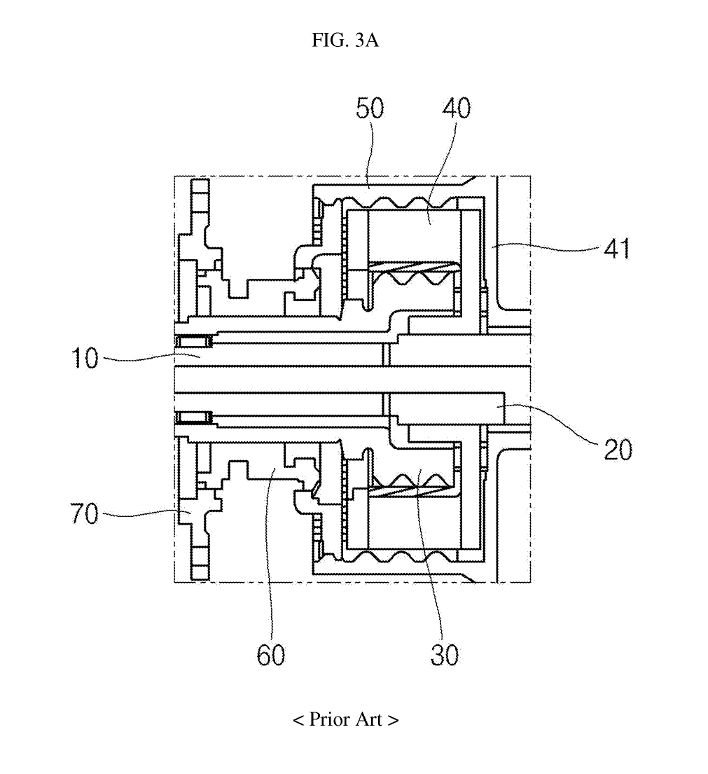

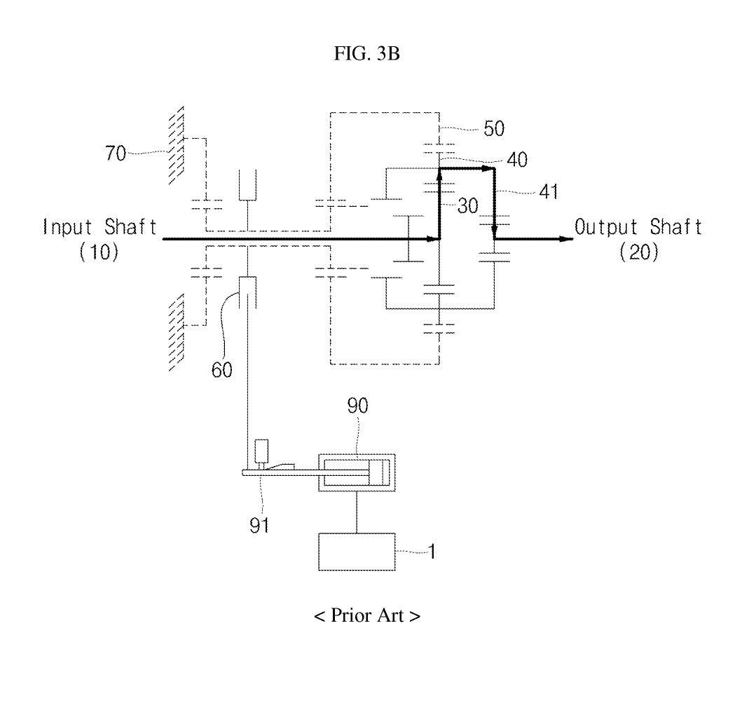

Overall, a structure of the transmission system of the transfer case according to the exemplary embodiment of the present invention is the same as that of the general transmission system show in FIGS. 2A and 3A.

In other words, the transmission system of the transfer case according to the present invention includes a planetary gear assembly mounted on an input shaft (connected to an output shaft of the transmission), and the planetary gear assembly includes a sun gear, a pinion gear, a ring gear and a carrier.

The ring gear of the planetary gear assembly is fixed to a housing, and the sun gear and the pinion gear are rotated within the ring gear. The transmission system further includes a shift sleeve connected to a hydraulic system, and the shift sleeve is disposed around the input shaft.

The aforementioned planetary gear assembly and transmission system are substantially the same with those shown in FIGS. 2A and 3A in view of configurations, and a detailed description and illustration thereof will not be repeated.

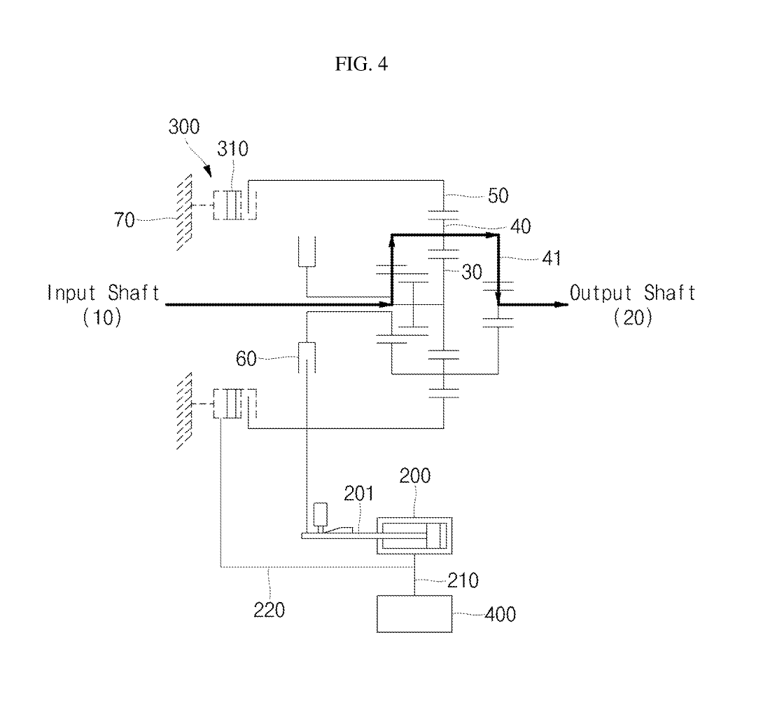

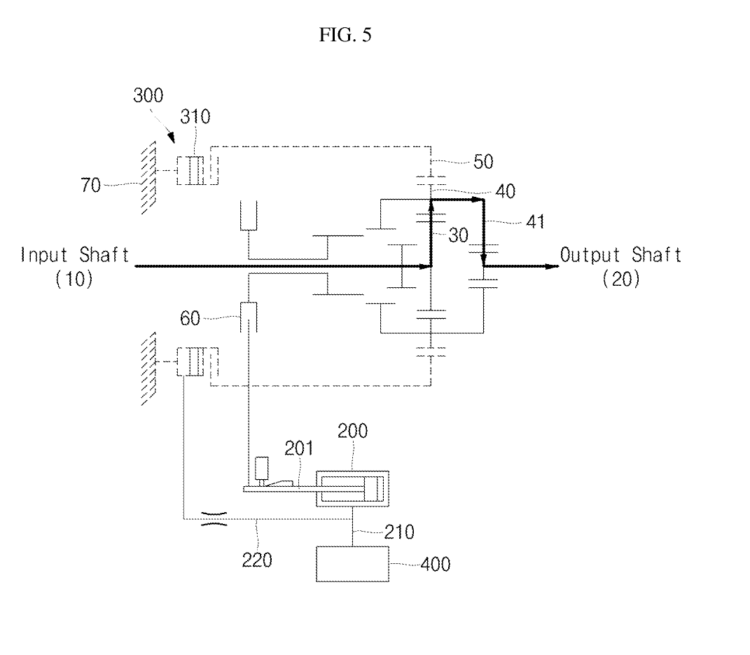

FIGS. 4 and 5 correspond to FIGS. 2B and 3B, respectively, and illustrate transmission routes of the transmission system of the transfer case according to the preferred embodiment of the present invention. Here, FIG. 4 illustrates the transmission system in the high range mode and FIG. 5 illustrates the transmission system in the low range mode.

For brevity, in FIGS. 4 and 5, the same constituents as those shown in FIGS. 2B and 3B are denoted by the same reference numerals. In addition, in FIGS. 4 and 5, arrows indicate power transmission routes, components marked by dotted lines are the components being in a stopped state and components marked by solid lines are the component being in a rotating state.

The following description will focus on differences structures between the transmission system according to the present invention and the transmission system shown in FIGS. 2B and 3B.

In addition to the planetary gear assembly including a sun gear 30, a pinion gear 40, a carrier 41 and a ring gear 50, and the shift sleeve 60, the transmission system of the transfer case according to the preferred embodiment of the present invention further includes a clutch piston apparatus 300.

Meanwhile, the hydraulic system disposed around the transfer case includes a hydraulic circuit (not shown) and a hydraulic cylinder 200 connected to the hydraulic circuit and receiving a hydraulic pressure from a hydraulic pressure source 400. An operating rod 201 of the hydraulic cylinder 200 is connected to the shift sleeve 60. Therefore, the shift sleeve 60 may be moved along an input shaft 10 by the hydraulic cylinder 200.

The aforementioned clutch piston apparatus 300 is mounted in a housing (not shown) of the transfer case and includes a clutch piston 310. The clutch piston 310 is connected to a hydraulic pressure source 400 of the hydraulic system. In other words, a second hydraulic pressure supply pipe 220 branched from a first hydraulic pressure supply pipe 210 connecting the hydraulic pressure source 400 and the hydraulic cylinder 200 is connected to the clutch piston 310 of the clutch piston apparatus 300.

Meanwhile, the clutch piston 310 of the clutch piston apparatus 300 is connected to the ring gear 50 of the planetary gear assembly. Therefore, the ring gear 50 does not rotate according to the operation of the clutch piston 310 supplied with the hydraulic pressure.

In the high range mode of the aforementioned transmission system, the shift sleeve 60 is connected to the sun gear 30 and the carrier 41 of the planetary gear assembly and the ring gear 50 is capable of freely rotating. Therefore, an input speed (i.e., a rotation speed of the sun gear 30) and an output speed (i.e., a rotation speed of the carrier 41 and a rotation speed of the output shaft 20) become equal to each other (the state shown in FIG. 4).

When a driver manipulates a shift lever to change the vehicle speed from the high range mode as described above to the low range mode, a hydraulic pressure is supplied from the hydraulic pressure source 400 to the hydraulic cylinder 200 (which operates the shift sleeve 60). The shift sleeve 60 is moved to the left in the drawing (opposite to the planetary gear assembly) by the operating rod 201 of the hydraulic cylinder 200. Therefore, the shift sleeve 60 and the planetary gear assembly are disengaged from each other, and the shift sleeve 60 is then moved to its terminal position.

Thereafter, the hydraulic pressure supplied from the hydraulic pressure source 400 is supplied to the clutch piston 310 of the clutch piston apparatus 300 through the second hydraulic pressure supply pipe 220, and the clutch piston 310 becomes in clutch-contact with the ring gear 50 through the hydraulic pressure to fix the ring gear 50 of the planetary gear assembly (the state shown in FIG. 5).

As the result, the ring gear 50 of the planetary gear assembly does not rotate, so that a speed reduction ratio satisfying the conditions of the low range mode is generated.

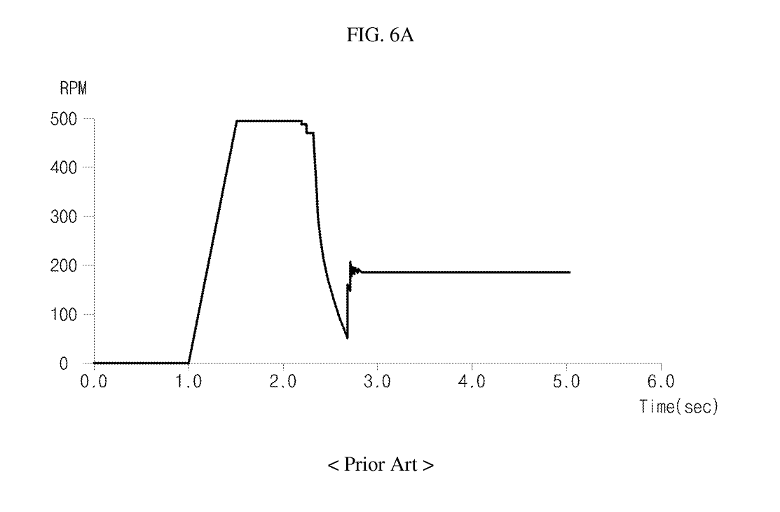

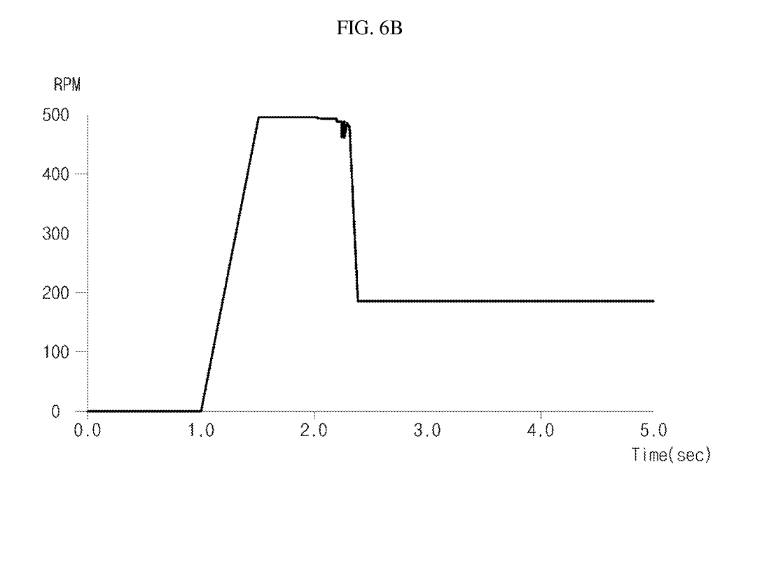

FIG. 6B is a graph illustrating a change in the number of revolutions during a transmission stage of the transmission system of the transfer case according to the present invention shown in FIGS. 4 and 5.

Compared with FIG. 6A illustrating a change in the number of revolutions during a transmission stage of the general transmission system of the transfer case, FIG. 6B shows that the transmission system of the transfer case according to the present invention can change the vehicle speed from the high range mode to the low range mode without a shifting shock even while a vehicle is traveling at a constant speed.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A transmission system for a transfer case including a planetary gear assembly having a sun gear, a pinion gear, a ring gear and a carrier, and a shift sleeve, the transmission system comprising:
a hydraulic system including a hydraulic circuit and a hydraulic cylinder connected to the hydraulic circuit and receiving a hydraulic pressure from a hydraulic pressure source; and
a clutch piston apparatus mounted on a housing of the transfer case and including a clutch piston receiving a hydraulic pressure from the hydraulic pressure source,
wherein an operating rod of the hydraulic cylinder is connected to the shift sleeve to shift the shift sleeve, and the clutch piston of the clutch piston apparatus is connected to the ring gear of the planetary gear assembly to make the ring gear not rotate according to the operation of the clutch piston supplied with the hydraulic pressure.

2. The transmission system of claim 1, wherein the hydraulic pressure source and the hydraulic cylinder are connected to each other through a first hydraulic pressure supply pipe, and the clutch piston is connected to the hydraulic pressure source through a second hydraulic pressure supply pipe branched from the first hydraulic pressure supply pipe.

3. A transmission system for a transfer case including a planetary gear assembly having a sun gear, a pinion gear, a ring gear and a carrier, and a shift sleeve, the transmission system comprising:
a hydraulic system including a hydraulic circuit and a hydraulic cylinder connected to the hydraulic circuit and receiving a hydraulic pressure from a hydraulic pressure source; and
a clutch piston apparatus mounted on a housing of the transfer case and including a clutch piston receiving a hydraulic pressure from the hydraulic pressure source.

4. The transmission system of claim 3, wherein the hydraulic cylinder includes an operating rod connected to the shift sleeve to shift the shift sleeve

5. The transmission system of claim 3, wherein the clutch piston of the clutch piston apparatus is connected to the ring gear of the planetary gear assembly to make the ring gear not rotate according to the operation of the clutch piston supplied with the hydraulic pressure.

6. The transmission system of claim 4, wherein the hydraulic pressure source and the hydraulic cylinder are connected to each other through a first hydraulic pressure supply pipe, and the clutch piston is connected to the hydraulic pressure source through a second hydraulic pressure supply pipe branched from the first hydraulic pressure supply pipe.

7. The transmission system of claim 5, wherein the hydraulic pressure source and the hydraulic cylinder are connected to each other through a first hydraulic pressure supply pipe, and the clutch piston is connected to the hydraulic pressure source through a second hydraulic pressure supply pipe branched from the first hydraulic pressure supply pipe.
